(19) United States
(12) Patent Application Publication
(10) Pub. No.: US 2026/0077317 A1
(43) Pub. Date: Mar. 19, 2026

(54) Gas Separation Membranes

(71) Applicants: Fujifilm Manufacturing Europe B.V., Tilburg (NL); Fujifilm Corporation, Tokyo (JP)

(72) Inventors: Petrus Henricus Maria Van Kessel, Tilburg (NL); Yujiro Itami, Tilburg (NL)

(21) Appl. No.: 19/108,504

(22) PCT Filed: Aug. 29, 2023
(86) PCT No.: PCT/EP2023/073622

§ 371 Date: Mar. 4, 2025

(30) Foreign Application Priority Data
Sep. 16, 2022 (NL) 2033048

(51) Int. Cl. B01D 71/52; B01D 69/12; B01D 71/70

(52) U.S. Cl. CPC B01D 71/5211; B01D 69/1216; B01D 69/125; B01D 71/701; B01D 2323/30

(57) ABSTRACT

A gas separation membrane comprising: (i) a porous substrate: (ii) a gutter layer comprising a cross-linked polysiloxane polymer; (iii) a discriminating layer comprising at least 60 w/w % of ethylene oxide (EO) groups and at least 0.15 mmol/g of thioether groups; and (iv) optionally a protective layer comprising a cross-linked polysiloxane polymer; wherein: (a) the gutter layer has an average thickness of less than 2.5 μm; and (b) the discriminating layer has an average thickness of greater than 0.2 μm and less than 5 μm.

This invention relates to gas-separation membranes (GSMs) and to their preparation and use.

For purifying gaseous mixtures e.g. natural gas and flue gas, the removal of undesired components can in some cases be achieved based on the relative size of the components (size-sieving).

U.S. Pat. No. 8,419,838 describes a process for preparing GSMs comprising a porous support and a discriminating layer comprising the steps of: (a) providing a porous support layer; (b) incorporating an inert liquid into the pores of the support layer; (c) applying a curable composition to the support layer; and (d) curing the composition, thereby forming the discriminating layer on the porous support.

U.S. Pat. No. 8,303,691 ('691) describes composite membranes comprising a discriminating layer and a porous support layer for the discriminating layer, characterised in that the discriminating layer comprises at least 60 wt % of oxyethylene groups and the discriminating layer has defined flux properties. However the composite membranes of '691 lack a gutter layer (GL).

JP2015160159 describes a GSM which includes a porous support body, a polymer layer arranged on the porous support body, and a gel layer comprising a high amount of liquid and being arranged on the polymer layer. However in such GSMs there is a risk of the liquid leaching-out of the gel layer in use, potentially resulting in pollution of a retentate stream with said liquid.

There is a need for strong, flexible GSMs having a high permeance and being capable of discriminating well between gases (e.g. between polar and non-polar gases, e.g. for the separation of carbon dioxide (CO₂) from nitrogen (N₂) or the separation of hydrogen sulfide (H₂S) from methane (CH₄)). Ideally the GSMs can operate continuously for a long period of time and at a high temperature (i.e. the GSMs preferably have good thermal ageing stability). Ideally such GSMs can be produced efficiently at high speeds using toxicologically acceptable liquids (particularly water). In this manner the GSMs could be made in a particularly cost effective manner and with no or few defects.

According to a first aspect of the present invention there is provided a gas separation membrane comprising:
(i) a porous substrate;
(ii) a gutter layer comprising a cross-linked polysiloxane polymer;
(iii) a discriminating layer comprising at least 60 w/w % of ethylene oxide (EO) groups and at least 0.15 mmol/g of thioether groups; and
(iv) optionally a protective layer comprising a cross-linked polysiloxane polymer;
wherein:
(a) the gutter layer has an average thickness of less than 2.5 μm; and
(b) the discriminating layer has an average thickness of greater than 0.2 μm and less than 5 μm.

In this specification the term “comprising” is to be interpreted as specifying the presence of the stated parts, steps or components, but does not exclude the presence of one or more additional parts, steps or components.

Reference to an element by the indefinite article “a” or “an” does not exclude the possibility that more than one of the element(s) is present, unless the context clearly requires that there be one and only one of the elements. The indefinite article “a” or “an” thus usually means “at least one”.

In this specification w/w % means wt %.

The primary purpose of the porous substrate is to provide the GSM with mechanical strength without materially reducing gas permeance.

The porous substrate is typically open-pored (before it is converted into the GSM), relative to the discriminating layer.

Examples of such porous substrates include polysulfones, polyethersulfones, polyimides, polyetherimides, polyamides, polyamideimides, polyacrylonitrile, polycarbonates, polyesters, polyacrylates, cellulose acetate, polyethylene, polypropylene, polyvinylidenefluoride, polytetrafluoroethylene, poly(4-methyl 1-pentene), polyacrylonitrile and especially polyesters. One may use a commercially available porous sheet material as the porous substrate. Alternatively one may prepare the porous substrate using techniques generally known in the art for the preparation of microporous materials.

Preferably the porous substrate comprises polyacrylonitrile (PAN), polysulphone (PSf), polyvinylidenefluoride (PVDF), polyether ether ketone (PEEK) and/or polytetrafluoroethylene (PTFE).

Optionally the porous substrate has been subjected to a corona discharge treatment, glow discharge treatment, flame treatment, ultraviolet light irradiation treatment or the like, e.g. for the purpose of improving its wettability and/or adhesiveness.

In a preferred embodiment, the porous substrate comprises pores and the average diameter of the pores half way through the porous substrate is in the range 0.001 to 10 μm, more preferably 0.01 to 1 μm. Furthermore, the pores of the porous substrate preferably have a smaller average diameter at the surface of the porous substrate than the average diameter of the pores half way through the porous substrate, e.g. an average diameter of the pores at the surface of the porous substrate is preferably in the range 0.001 to 0.1 μm, more preferably in the range 0.005 to 0.05 μm.

The average pore diameters of the porous substrate at its surface and half way through may be determined by, for example, viewing the surface of the porous substrate before it is converted to the GSM by scanning electron microscopy (“SEM”) and by cutting through the porous substrate and measuring the diameter of the pores half way through the porous substrate, again by SEM. The average pore diameters may then be calculated from measurements of a plurality of pore diameter measurements (e.g. an average of 10,000 pore size measurements).

The porosity at the surface of the porous substrate may also be expressed as a % surface porosity, i.e.

$$\% surface porosity = 100 \% \times \frac{( area of the surface which is missing due to pores )}{( total surface area )}$$

The areas required for the above calculation may be determined by inspecting the surface of the porous substrate by SEM. Thus, in a preferred embodiment, the porous substrate has a % surface porosity >1%, more preferably >3%, and especially >10%.

The porosity of the porous substrate may also be expressed as a CO₂ gas permeance (units are m³ (STP)/(m²·kPa·s)). Preferably the porous substrate has a CO₂ gas permeance of 5 to 150×10⁻⁵ m³ (STP)/(m²·kPa·s), more preferably of 5 to 100×10⁻⁵ m³ (STP)/(m²·kPa·s), most preferably of 7 to 70×10⁻⁵ m³ (STP)/(m²·kPa·s). STP refers to standard pressure and temperature which are defined here as 25.0° C. and 101.325 kPa.

Alternatively the porosity of the porous substrate may be characterised by measuring the N₂ gas flow rate through the porous substrate. Gas flow rate can be determined by any suitable technique, for example using a Porolux™ 1000 device, available from Porometer.com. Typically the Porolux™ 1000 is set at the maximum pressure (about 34 bar) and one measures the flow rate (L/min) of N₂ gas through the porous substrate under test. The N₂ flow rate through the porous substrate at a pressure of about 34 bar for an effective sample area of 2.69 cm² (effective diameter of 18.5 mm) is preferably >1 L/min, more preferably >5 L/min, especially >10 L/min, more especially >25 L/min. The higher of these flow rates are preferred because this reduces the likelihood of the gas flux of the resultant membrane being reduced by the porous substrate.

The above pore sizes and porosities refer to the porous substrate before it has been converted into the GSM of the present invention.

The porous substrate preferably has an average thickness of 20 to 500 μm, preferably 50 to 400 μm, especially 100 to 300 μm.

The gutter layer (GL) is attached to the porous substrate and preferably comprises pores having an average diameter <1 nm. The presence of such small pores means that the GL is permeable to gasses, although typically the GL has low ability to discriminate between gases.

Preferably the GL has an average thickness of more than 0.01 μm. The GL preferably has an average thickness of 0.01 to 2.5 μm, more preferably 0.02 to 1.0 μm, even more preferably 0.05 to 0.6 μm, especially 0.07 to 0.20 μm, e.g. 0.09 to 0.11 μm, 0.13 to 0.15 μm or 0.17 to 0.19 μm. The average thickness of the GL may be determined by cutting through the GSM and examining its cross section by SEM. The average thickness of the GL is measured from the surface of the porous substrate outwards, i.e. any GL which is present within the pores of the porous substrate is not taken into account.

The cross-linked polysiloxane polymer present in the GL is preferably obtained by crosslinking a composition comprising a curable polysiloxane polymer having at least two polymerisable groups, e.g. at least two polymerisable groups such as ethylenically unsaturated groups (e.g. (meth)acrylic groups (e.g. CH₂═CR C(O)— groups), especially (meth)acrylate groups (e.g. CH₂═CR C(O)O— groups), (meth)acrylamide groups (e.g. CH₂═CR C(O)NR— groups), wherein each R independently is H or CH₃), oxetane and especially epoxide groups (e.g. glycidyl and epoxycyclohexyl groups), which are cured after application to the porous substrate.

Examples of curable polysiloxane polymers which may be used to form the cross-linked polysiloxane polymer present in the GL include, but are not limited to, polysiloxane based polymers such as α,ω-(epoxycyclohexylethyl-dimethylsiloxy)-polydimethylsiloxane, α,ω-(epoxycyclohexylethyl-dimethylsiloxy)-poly-[(epoxycyclohexylethyl)methylsiloxane-co-dimethylsiloxane], α,ω-(trimethylsiloxy)-poly-[(epoxycyclohexylethyl)methylsiloxane-co-dimethylsiloxane], mixtures thereof or partially crosslinked polymers made thereof.

Preferably the GL is obtained by curing a composition comprising a curable polysiloxane polymer and 0.1 to 25 w/w % and even more preferred 0.2 to 10 w/w % in total of curable polysiloxane polymer.

The composition which may be used to prepare the GL further preferably comprises an initiator which facilitates curing of polymerisable components present in the composition. Any initiator may be used, e.g. a thermal initiator, photo-initiator a Lewis acid and/or a Lewis base. The initiator may be anionic, cationic or non-ionic. Also the curing may comprise inter- and/or intra-molecular polymerization.

Photo-initiators are usually required when the curing uses light, for example ultraviolet (“UV”) light.

Preferred photo-initiators for use in cationic UV cure include, but are not limited to organic salts of non-nucleophilic anions, e.g. hexafluoroarsinate anion, antimony (V) hexafluoride anion, phosphorus hexafluoride anion, tetrafluoroborate anion and tetrakis (2,3,4,5,6-pentafluorophenyl) boranuide anion, (4-phenylthiophenyl)diphenylsulfonium triflate; triphenylsulfonium triflate; Irgacure® 270 (available from BASF); triarylsulfonium hexafluoroantimonate; triarylsulfonium hexafluorophosphate; CPI-100P (available from SAN-APRO); CPI-210S (available from SAN-APRO) and especially Irgacure® 290 (available from BASF), CPI-100P from San-Apro Limited Japan, of triphenylsulphonium hexafluorophosphate, hexafluoroantimonate, triphenylsulphonium triphenylsulphonium tetrakis (pentafluorophenyl) borate, (thiodi-4,1-phenylene)bis(diphenylsulfonium) bis(hexafluorophosphate), 4,4′-bis[diphenylsulphonio]diphenylsulfide bishexafluorophosphate, 4,4′-bis[di(beta-hydroxyethoxy)phenylsulphonio]diphenylsulfide bishexafluoroantimonate, 4,4′-bis[di(beta-hydroxyethoxy)phenylsulphonio]diphenylsulfide bishexafluorophosphate, 7-[di(p-toluyl) sulphonio]-2-isopropylthioxanthone hexafluoroantimonate, 7-[di(p-toluyl) sulphonio]-2-isopropylthioxanthone tetrakis (pentafluorophenyl) borate, 4-phenylcarbonyl-4′-diphenylsulphonio-diphenylsulphide hexafluorophosphate, 4-(p-tert-butylphenylcarbonyl)-4′-diphenylsulphonio-diphenylsulphide hexafluoroantimonate, and 4-(p-tert-butylphenylcarbonyl)-4′-di(p-toluyl) sulphonio-diphenylsulphide tetrakis (pentafluorophenyl) borate (e.g. DTS-102, DTS-103, NDS-103, TPS-103, MDS-103 from Midori Chemical Co. Ltd.), phenyliodonium hexafluoroantimonate (e.g. CD-1012 from Sartomer Corp.), diphenyliodonium tetrakis (pentafluorophenyl) borate, diphenyliodonium hexafluorophosphate, diphenyliodonium hexafluoroantimonate, diphenyliodonium tetrafluoroborate, bis(dodecylphenyl)iodonium hexafluoroantimonate, bis(4-tert-butylphenyl)iodonium hexafluorophosphate, di(4-nonylphenyl)iodonium hexafluorophosphate, MPI-103, BBI-103 from Midori Chemical Co. Ltd., certain iron salts (e.g. Irgacure™ 261 from Ciba), 4-isopropyl-4′-methyldiphenyliodonium tetrakis(pentafluorophenyl) borate ((C₄₀H₁₈BF₂₀I)) available under the name I0591 from TCI), Bis[4-n-alkyl(C10˜13)phenyl]iodonium tetrakispentafluorophenylborate (WPI-124 from WAKO), Bis[4-n-alkyl(C10˜13)phenyl]iodonium Hexafluorophosphate (WPI-113 from WAKO), Bis[4-n-alkyl(C10˜13)phenyl]iodonium Hexafluoroantimonate (WPI-116 from WAKO), Bis(4-tert-butylphenyl)iodium hexafluorophosphate (WPI-170 from WAKO) and 4-(octyloxy)phenyl](phenyl)iodonium hexafluoroantimonate (C₂₀H₂₆F₆IOSb, available as AB153366 from ABCR GmbH Co).

Especially preferred initiators include organic salts of non-nucleophilic anions, e.g. hexafluoroarsinate anion, antimony (V) hexafluoride anion, phosphorus hexafluoride anion, tetrafluoroborate anion and tetrakis (2,3,4,5,6-pentafluorophenyl) boranuide anion. Commercially available cationic photo-initiators include UV-9380c, UV-9390c (manufactured by Momentive performance materials), UVI-6974, UVI-6970, UVI-6990 (manufactured by Union Carbide Corp.), CD-1010, CD-1011, CD-1012 (manufactured by Sartomer Corp.), Adekaoptomer™ SP-150, SP-151, SP-170, SP-171 (manufactured by Asahi Denka Kogyo Co., Ltd.), Irgacure™ 250, Irgacure™ 261 (Ciba Specialty Chemicals Corp.), CI-2481, CI-2624, CI-2639, CI-2064 (Nippon Soda Co., Ltd.), DTS-102, DTS-103, NAT-103, NDS-103, TPS-103, MDS-103, MPI-103, BBI-103 (Midori Chemical Co., Ltd.), Bis[4-n-alkyl(C10˜13)phenyl]iodonium tetrakispentafluorophenylborate (WPI-124 from WAKO), Bis[4-n-alkyl(C10˜13)phenyl]iodonium Hexafluorophosphate (WPI-113 from WAKO), Bis[4-n-alkyl(C10˜13)phenyl]iodonium Hexafluoroantimonate (WPI-116 from WAKO), Bis(4-tert-butylphenyl) iodium hexafluorophosphate (WPI-170 from WAKO) and 4-isopropyl-4′-methyldiphenyliodonium tetrakis(pentafluorophenyl) borate ((C₄₀H₁₈BF₂₀I) available under the name I0591 from TCI). The above mentioned cationic photo-initiators can be used either individually or in combination of two or more. Most preferred are sulfonium and iodonium salts.

Ring opening adjuvants include cationic photoinitiators, Lewis acids (e.g. titanium (IV) isopropoxide) and Lewis bases (e.g. Phosphazene bases, e.g. P1-t-Bu-tris (tetramethylene) and/or N,N,N′,N′-tetramethylethylenediamine).

A single type of initiator may be used but also a combination of several different types.

Optionally when no initiator is included in the composition used to form the GL, the composition can advantageously be cured by electron-beam exposure. Preferably the electron beam output is between 50 and 300 keV. Curing can also be achieved by plasma or corona exposure. Preferably the composition used to form the GL comprises 0 and 2 w/w % initiator, even more preferred between 0.01 and 0.5 w/w % initiator.

Preferably the composition used to form the GL comprises 50 to 99.9 w/w % inert solvent, more preferably 90 to 99.5 w/w % inert solvent.

Inert solvents are not curable and do not cross-link with any component of the composition.

Examples of inert solvents include hydrocarbon-based solvents, ether-based solvents, ester-based solvents, amide-based solvents, ketone-based solvents, sulfoxide-based solvents, sulfone-based solvents, nitrile-based solvents and organic phosphorus-based solvents. Examples of hydrocarbon-based solvents include hexanes, heptanes, octanes, benzene, toluene, xylenes, and mixtures comprising two or more thereof.

Examples of other inert solvents include dimethyl sulfoxide, dimethyl imidazolidinone, sulfolane, N-methyl pyrrolidone, dimethyl formamide, acetonitrile, acetone, 1,4-dioxane, 1,3-dioxane, 1,3-dioxolane, tetramethyl urea, hexamethyl phosphoramide, hexamethyl phosphorotriamide, pyridine, propionitrile, 2-butanone, cyclohexanone, tetrahydrofuran, tetrahydropyran, 2-methyltetrahydrofuran, ethylene glycol diacetate, cyclopentylmethylether, ethyl acetate, n-propyl acetate, i-propyl acetate, n-butyl acetate, i-butyl acetate, γ-butyrolactone and mixtures comprising two or more thereof.

The composition which may be used to form the GL is preferably applied to the porous substrate such that when the composition is cured, the resultant GL formed on top of the porous substrate has the preferred thickness specified above.

In view of the foregoing, the GL is preferably obtained by a process comprising curing a composition comprising:
(1) 0.1 to 25 w/w %, more preferably 0.2 to 10 w/w %, of the curable polysiloxane polymer;
(2) 0 to 5 w/w %, more preferably 0.01 to 0.5 w/w %, of initiator; and
(3) 70 to 99.9 w/w %, more preferably 90 to 99.5 w/w %, of inert solvent.

Preferably the amount of (1)+(2)+(3) adds up to 100%. This does not exclude the presence of other components other than (1), (2) and (3) but it sets the total amount of these three components. In one embodiment the composition consists solely of components (1), (2) and (3).

The composition which may be used to form the gutter may be cured by any suitable technique, for example by thermal curing and/or radiation curing. Suitable radiation curing techniques include gamma rays, x-rays and especially ultraviolet light or electron beams. Suitable thermal curing techniques include radiation heating (e.g. infrared, laser and microwave), convection and conduction heating (hot gas, flame, oven and hot shoe), induction heating, ultrasonic heating and resistance heating.

The discriminating layer (DL) is preferably obtained by curing a composition comprising curable monomers comprising ethylene oxide (EO) groups and/or curable polymers comprising EO groups, in each case preferably in the form of chains of EO groups. Preferred chains of EO groups are poly(ethylene oxide) groups, for example groups of the formula —(CH₂CH₂O)ₙ— wherein n has a value of 6 to 50, preferably 6 to 30 and more preferably 8 to 25. Such curable monomers and polymers comprising EO groups preferably further comprise at least one, preferably at least two, polymerisable groups. The polymerisable groups are preferably each independently as described above in relation to the curable polysiloxane polymer. Particularly preferred polymerisable groups which may be present in the curable monomers comprising ethylene oxide (EO) groups and/or curable polymers comprising EO groups include ethylenically unsaturated groups, especially (meth)acrylic groups (e.g. CH₂═CR C(O)—groups), more especially (meth)acrylate groups (e.g. CH₂═CR C(O)O— groups) and (meth)acrylamide groups (e.g. CH₂═CR C(O)NR— groups), wherein each R independently is H or CH₃.

Preferably the average length of ethylene oxide chains in the curable monomers or polymers used to form the DL is from 6 to 50 EO groups, more preferably 6 to 30 EO groups, even more preferably 8 to 25 EO groups, e.g. 13 or 18 EO groups. These preferences arise because use of curable monomers or polymers comprising the above-preferred average length of ethylene oxide chains can provide DLs which are defect-free and GSMs having good permeability to polar gases compared to non-polar gases, thereby facilitating the purification of mixtures comprising polar and non-polar gases.

Preferably the DL comprises at least 60 w/w % of EO groups, more preferably at least 70 w/w % of EO groups and even more preferably at least 80 w/w % of EO groups.

In one embodiment all of the curable monomers and/or polymers present in the composition used to prepare the DL comprise EO groups. In another embodiment, the composition used to prepare the DL comprises at least one curable monomer or polymer which comprises EO groups and at least one curable monomer or polymer which is free from EO groups.

As examples of curable monomers and polymers comprising EO groups there may be mentioned poly(ethylene glycol)di(meth)acrylate, bisphenol A ethoxylate di(meth)acrylate, neopentyl glycol ethoxylate di(meth)acrylate, propanediol ethoxylate di(meth)acrylate, butanediol ethoxylate di(meth)acrylate, hexanediol ethoxylate di(meth)acrylate, poly(ethylene glycol-co-propylene glycol)di(meth)acrylate, poly(ethylene glycol)-block-poly(propylene glycol)-block-poly(ethylene glycol)di(meth)acrylate, glycerol ethoxylate tri (meth)acrylate, trimethylolpropane tri (meth)acrylate, trimethylolpropane ethoxylate tri (meth)acrylate, pentaerythrytol tetra (meth)acrylate, pentaerythrytol ethoxylate tetra (meth)acrylate ditrimethylolpropane tetra (meth)acrylate, ditrimethylolpropane ethoxylate tetra (meth)acrylate, dipentaerythrytol hexa(meth)acrylate, dipentaerythrytol ethoxylate hexa(meth)acrylate, poly(ethylene glycol)-(meth)acrylate, methoxy-poly(ethylene glycol)-(meth)acrylate, reaction products of (co-) polymers thereof with acrylic acid or alternative acrylating agents, reaction products thereof with polyfunctional thiol containing materials such as 2,2′-(ethylenedioxy) diethanethiol, α,ω-poly(ethylene glycol) diethanethiol, trimethylolpropane tris(3-mercaptopropionate), ethoxylated trimethylolpropane tris(3-mercaptopropionate), pentaerythritol tetrakis(3-mercaptopropionate), ethoxylated pentaerythritol tetrakis(3-mercaptopropionate), dipentaerythritol hexakis (3-mercaptopropionate), ethoxylated dipentaerythritol hexakis (3-mercaptopropionate), tris[2-(3-mercaptopropionyloxy)ethyl]isocyanurate, hexaglycerol octakis (3-mercaptopropionate), ethoxylated hexaglycerol octakis (3-mercaptopropionate) and combinations of two or more thereof.

Preferably the DL is obtained from curing a composition comprising 0.5 to 25 w/w %, more preferably 5 to 15 w/w %, of curable monomers and/or polymers comprising EO groups.

Preferred curable monomers and/or polymers comprising EO groups which may be used to for the DL have a sulphur content of at least 0.1 w/w %, more preferably at least 0.25 w/w %, even more preferably at least 0.5 w/w %, especially at least 1 w/w %, e.g. 1.5 to 1.75 w/w %, 2 to 2.5 w/w %, 3 to 5 w/w %, 8 to 12 w/w %, 15 to 20 w/w % or 23 to 27 w/w %, relative to the weight of the curable monomer or polymer.

In one embodiment the curable polymer comprising EO groups which may be used to form the DL comprises a plurality of thioether groups, e.g. three or more thioether groups.

In another embodiment, all or substantially all of the sulphur content of the curable polymer comprising EO groups which may be used to for the DL is provided by thioether groups.

Preferably the DL comprises a plurality of thioether groups (e.g. of the formula —CH₂—S—CH₂—).

Preferably all or substantially all of the sulphur content of the curable polymer comprising EO groups and all or substantially all of the sulphur content of the discriminating layer is provided by thioether groups.

The DL has a thioether content of at least 0.15 mmol/g, preferably between 0.15 and 2.0 mmol/g, more preferably between 0.15 and 1.0 mmol/g and even more preferably between 0.15 and 0.60 mmol/g. Higher amounts of thioether above 2.0 mmol/g will result in GSMs having too low permeance for separating polar gases (e.g. H₂S) from non-polar gases (e.g. CH₄).

Optionally the composition which may be used to form the DL further comprises one or more further curable monomers or curable polymers, e.g. comprising one or more polymerisable groups (e.g. one, two or three polymerisable groups, especially two polymerisable groups).

Examples of such further monomers or polymers comprising only one polymerisable group include, but are not limited to, dimethyl (aminopropyl) (meth) acrylamide, allyl (meth)acrylate, (meth)acrylic acid and vinyl (meth)acrylate.

Other examples of such further monomers or polymers which may be included in the composition used to form the DL include, but are not limited to, monomers or polymers comprising one or more thiol groups, which can be advantageously cured using the thiol-ene reaction mechanism. Examples of such monomers or polymers include, but are not limited to, 2,2′-(ethylenedioxy) diethanethiol, α,ω-poly(ethylene glycol) diethanethiol, trimethylolpropane tris(3-mercaptopropionate), ethoxylated trimethylolpropane tris(3-mercaptopropionate), pentaerythritol tetrakis(3-mercaptopropionate), ethoxylated pentaerythritol tetrakis(3-mercaptopropionate), dipentaerythritol hexakis (3-mercaptopropionate), ethoxylated dipentaerythritol hexakis (3-mercaptopropionate), tris[2-(3-mercaptopropionyloxy)ethyl]isocyanurate, hexaglycerol octakis (3-mercaptopropionate) and ethoxylated hexaglycerol octakis (3-mercaptopropionate).

The amount of further monomers or polymers present in the composition which may be used to form the DL is preferably 0 to 12.5 w/w %, more preferably 0 to 10 w/w %, especially 0 to 5 w/w %, relative to the total weight of the composition used to form the DL, excluding the inert solvent(s).

Preferably the composition which may be used to form the discriminating layer comprises an inert solvent. As mentioned above, inert solvents are not curable and do not cross-link with any component of the composition.

Examples of inert solvents which may be included in the composition used to form the DL include, but are not limited to, alcohol-based solvents, ether-based solvents, ester-based solvents, amide-based solvents, ketone-based solvents, sulfoxide-based solvents, sulfone-based solvents, nitrile-based solvents and organic phosphorus-based solvents.

Examples of inert solvents which may be included in the composition used to form the DL include, but are not limited to, methanol, ethanol, isopropanol, n-butanol, ethylene glycol, propylene glycol, diethylene glycol, dipropylene glycol, dimethyl sulfoxide, dimethyl imidazolidinone, sulfolane, N-methyl pyrrolidone, dimethyl formamide, acetonitrile, acetone, 1,4-dioxane, 1,3-dioxane, 1,3-dioxolane, tetramethyl urea, hexamethyl phosphoramide, hexamethyl phosphorotriamide, pyridine, propionitrile, 2-butanone, cyclohexanone, tetrahydrofuran, tetrahydropyran, 2-methyltetrahydrofuran, ethylene glycol diacetate, cyclopentylmethylether, ethyl acetate, n-propyl acetate, i-propyl acetate, n-butyl acetate, i-butyl acetate, γ-butyrolactone, 1-Methoxy-2-propanol, (2-methoxy-1-methyl-ethyl)acetate and mixtures comprising two or more thereof.

Especially preferred inert solvents which may be included in the composition used to form the DL include methyl ether ketone, n-butyl acetate, ethyl acetate, cyclopentyl methyl ether, (2-methoxy-1-methyl-ethyl)acetate and 2-methyltetrahydrofuran.

The inert solvent which may be included in the composition used to form the DL optionally comprises a single inert solvent or a combination of two or more inert solvents. In one embodiment the inert solvent which may be included in the composition used to form the DL has a low boiling point e.g. a boiling point below 150° C. Solvents having a low boiling point can be easily removed after curing by evaporation, avoiding the need for a washing step for removal of the solvent.

The amount of inert solvent present in the composition which may be used to form the DL is preferably in the range of 40 to 99 w/w %, more preferably 70 to 95 w/w %, especially preferred 80 to 95 w/w %, relative to the weight of the composition.

Preferably the composition which may be used to form the discriminating layer further comprises a surfactant, e.g. 0.05 to 7.5 w/w % and especially 0.1 to 5 w/w % of surfactant, relative to the total weight of the composition, excluding the inert solvent(s).

Preferred surfactants are ionic and non-ionic surfactants, for example ethoxylated and alkoxylated fatty acids, ethoxylated amines, ethoxylated alcohol, alkyl and nonyl-phenol ethoxylates, ethoxylated sorbitan. The most preferred surfactant is a polyether-modified acryl functional polydimethylsiloxane (available as UV-3530 from BYK). Optionally the composition used to form the DL comprises one or more further additives, binders, etc. (e.g. in an amount of up to 5 w/w %, relative to the total weight of the composition, excluding the inert solvent(s)).

The composition which may be used to form the DL preferably further comprises an initiator which facilitates curing of the polymerisable components present in the composition. Any initiator capable of polymerizing an ethylenically unsaturated group may be used, e.g. a thermal initiator or a photo-initiator.

Thermal initiators include, but are not limited to azo initiators and organic or inorganic peroxide.

Suitable photo-initiators include, but are not limited to Radical Type I and/or type II photo-initiators.

Examples of radical type I photo-initiators are as described in WO 2007/018425, page 14, line 23 to page 15, line 26, which are incorporated herein by reference thereto.

Examples of radical type II photo-initiators are as described in WO 2007/018425, page 15, line 27 to page 16, line 27, which are incorporated herein by reference thereto.

For monomers or polymers comprising one or more acrylate group, type I photo-initiators are preferred. Especially alpha-hydroxyalkylphenones, such as 2-hydroxy-2-methyl-1-phenyl propan-1-one, 2-hydroxy-2-methyl-1-(4-tert-butyl-)phenylpropan-1-one, 2-hydroxy-[4′-(2-hydroxypropoxy)phenyl]-2-methylpropan-1-one, 2-hydroxy-1-[4-(2-hydroxyethoxy)phenyl]-2-methyl propan-1-one, 1-hydroxycyclohexylphenylketone and oligo[2-hydroxy-2-methyl-1-{4-(1-methylvinyl)phenyl}propanone], alpha-aminoalkylphenones, alpha-sulfonylalkylphenones and acylphosphine oxides such as 2,4,6-trimethylbenzoyl-diphenylphosphine oxide, ethyl-2,4,6-trimethylbenzoyl-phenylphosphinate and bis(2,4,6-trimethylbenzoyl)-phenylphosphine oxide, are preferred.

Preferably the composition used to form the DL comprises 0.02 to 12.5 w/w %, more preferably 0.1 to 5 w/w % photoinitiator, relative to the total weight of the composition, excluding the inert solvent(s).

The composition to form the DL may comprise less than 30 w/w % liquids selected from the group consisting of ionic liquids, glycerin, polyglycerin, polyethylene glycol, polypropylene glycol, polyethylene oxide, and amine compounds having 15 or less carbons. In a preferred embodiment the amount of liquids in the DL is less than 25 w/w %, even more preferred less than 10 w/w % and in the most preferred embodiment the DL is essentially free from liquids selected from the group consisting of ionic liquids, glycerin, polyglycerin, polyethylene glycol, polypropylene glycol, polyethylene oxide, and amine compounds having 15 or less carbons. Essentially free in the context of this invention means that the amounts present in the composition used to form the DL compositions are far below 0.1 w/w % and preferably below 0.05 w/w % and even more preferably below 0.02 w/w %.

In view of the foregoing, the composition which may be used to prepare the DL preferably comprises:
(a) 1 to 25 w/w %, more preferably 5 to 15 w/w %, of curable monomers and/or polymers comprising EO groups;
(b) 0 to 1.25 w/w %, more preferably 0 to 0.5 w/w %, of curable monomers and/or polymers which are free from EO groups;
(c) 40 to 99 w/w %, more preferably 80 to 95 w/w %, of inert solvent;
(d) 0.005 to 0.75 w/w %, more preferably 0.01 to 0.5 w/w %, of surfactant; and
(e) 0.002 to 1.25 w/w %, more preferably 0.01 to 0.5 w/w %, of initiator.

Preferably the amount of (a)+(b)+(c)+(d)+(e) adds up to 100%. This does not exclude the presence of other components other than (a), (b), (c), (d) and (e) but it sets the total amount of these five components. In one embodiment the composition consists solely of components (a), (b), (c), (d) and (e).

Preferably the composition which may be used to form the DL is substantially free from (e.g. contains less than 0.1 w/w %, more preferably less than 0.01 w/w %) particulate inorganic particles, e.g. substantially free from (e.g. contains less than 0.1 w/w %, more preferably less than 0.01 w/w %) inorganic particles of size (diameter) 0.4 to 5.1 μm.

The composition which may be used to form the DL is preferably free from (e.g. contains less than 0.1 w/w %, more preferably less than 0.01 w/w %) zeolites, porous silicas, carbon nanotubes, graphene oxides and/or metal-organic frameworks (MOFs).

In this way, a smooth, homogenous DL can be obtained.

The composition which may be used to form the DL may be cured by any suitable technique, for example by thermal curing and/or radiation curing. Suitable radiation curing techniques include gamma rays, x-rays and especially ultraviolet light or electron beams. Suitable thermal curing techniques include radiation heating (e.g. infrared, laser and microwave), convection and conduction heating (hot gas, flame, oven and hot shoe), induction heating, ultrasonic heating and resistance heating.

The DL preferably has an average thickness of 0.21 to 5 μm, more preferably 0.3 to 3 μm, especially 0.5 to 2.5 μm, most preferably 1 to 2 μm, e.g. 1.1, 1.25, 1.50 or 1.75 μm.

The average thickness of the DL may be determined by cutting through the membrane and examining its cross section by SEM.

Surprisingly the present invention can provide very thin DLs after coating which often are free from defects. This provides GSMs having very high permeance and good selectivity without defects (defect-free) which are especially useful for separating polar gases (e.g. H₂S) from non-polar gases.

The EO and sulphur content of DL may be calculated from the amounts and identity of the components used to form it. Where the amounts and identity of the components used to form the DL are not known, for example where a GSM comprising a DL has been obtained from a supplier who refuses to provide this information, one may determine the identity and amounts of components from which the DL was obtained by analysis of the DL, e.g. using pyrolysis and gas chromatography. A more preferred technique to analyze the components of the DL is to hydrolyze the DL and analyze the hydrolysis products by size-exclusion chromatography or mass spectrometry. This technique is particularly useful for determining the identity and ratio of monomers used to form the DL. A suitable pyrolysis and gas chromatography technique which may be used to determine the composition of the DL in a GSM is described in the paper by H. Matsubara and H. Ohtani entitled “Rapid and Sensitive Determination of the Conversion of UV-cured Acrylic Ester Resins by Pyrolysis-Gas Chromatography in the Presence of an Organic Alkali” in Analytical Sciences, 2007, 23 (5), 513.

A suitable method to determine the average pore size of a GSM is to inspect the surface thereof (typically the DL) by scanning electron microscope (SEM) e.g. using a Jeol JSM-6335F Field Emission SEM, applying an accelerating voltage of 2 kV, working distance 4 mm, aperture 4, sample coated with Pt with a thickness of 1.5 nm, magnification 100,000×, 3° tilted view.

Preferably the DL has an average pore size of below 10 nm, more preferably below 5 nm, especially below 2 nm. The maximum preferred pore size depends on the application e.g. on the gases to be separated.

A method for obtaining an indication of the porosity of a GSM is to measure its permeance to a liquid, e.g. to water. Preferably the permeance of the GSM of the present invention to liquids is very low, i.e. the average pore size of the GSM is such that its pure water permeance at 20° C. is less than 6.10⁻⁸ m³/(m²·kPa·s), more preferably less than 3·10⁻⁸ m³/(m²·kPa·s).

Preferably the GSM of the present invention is liquid-free (e.g. the GSM has been dried to remove liquids).

In one embodiment of the present invention the GSM comprises a protective layer (PL). Typically the GSM has the GL on one side of the DL and the PL on the opposite side of the DL and the GL is in contact with the porous substrate.

Preferably the GSM of the present invention has an average dry thickness (excluding the porous substrate) in the range 0.05 to 100 μm, more preferably 0.09 to 25 μm, even more preferably 0.15 to 5 μm and especially 0.25 to 3.5 μm.

Preferably the GSM of the present invention (after curing and optional washing and/or drying) may comprise less than 30 w/w % liquids selected from the group consisting of ionic liquids, glycerin, polyglycerin, polyethylene glycol, polypropylene glycol, polyethylene oxide, and amine compounds having 15 or less carbons. In a preferred embodiment the amount of liquids in the GSM is less than 25 w/w %, even more preferred less than 10 w/w % and in the most preferred embodiment the GSM is essentially free from liquids selected from the group consisting of ionic liquids, glycerin, polyglycerin, polyethylene glycol, polypropylene glycol, polyethylene oxide, and amine compounds having 15 or less carbons. Essentially free in the context of this inventions means that the amounts present in the GSM are below 0.1 w/w % and preferably below 0.05 w/w % and even more preferably below 0.02 w/w %. One may prepare GSMs having low levels of the aforementioned liquids by preparing the GL, DL and PL (when present) from compositions which are free from or substantially free from those liquids.

In one embodiment the PL, when present, is obtained by applying to the DL a composition as described in relation to formation of the GL and curing said composition. The compositions used to prepare the GL and optional PL may be identical or different to each other.

The GSM of the present invention preferably has a CO₂/N₂ selectivity (αCO₂/N₂) at 40° C.≥15, more preferably ≥17, for example ≥18, 19, 20, 21, 22, 23, 24 or even higher than 25. Preferably the selectivity of the GSM is determined by a process comprising exposing the GSM to a gas mixture having a composition of CO₂/CH₄/n-C₄H₁₀/N₂ of 13.0/79.0/0.5/7.0 by volume at 40° C. and a feed pressure of 4000 kPa.

Preferably the GSM of the present invention has a H₂S/CH₄ selectivity (αH₂S/CH₄) at 56° C.≥18, more preferably ≥19, 20, 21, 22, 23, 24 or even higher than 25. Preferably the selectivity of the GSM is determined by a process comprising exposing the GSM to a gas mixture having a composition of CO₂/CH₄/N₂/H₂S of 31.73/37.85/3.23/0.05 by volume at 56° C. and a feed pressure of 3200 kPa.

The optional PL typically performs the function of providing a scratch-and crack-resistant layer on top of the DL and/or sealing any defects present in the DL.

The optional PL preferably has an average thickness 800 to 2000 nm, preferably 900 to 1800 nm, especially 1000 to 1500 nm, more especially 1100 to 1300 nm, e.g. 1150 to 1250 nm. The thickness of the various layers (e.g. the GL, DL and optional protective layer) may be determined by cutting through the membrane and examining its cross section by SEM.

The optional PL preferably comprises pores of average diameter <1 nm.

The optional PL preferably has surface characteristics which influence the functioning of the GSM, for example by making the surface of the GSM more hydrophilic.

In a preferred embodiment the GL and the optional PL layer are obtained from curable compositions which comprise the same components. This leads to efficiencies in manufacturing and raw material costs. Preferably the amount of each component used to make the optional PL is within at most 10%, more preferably within at most 5%, of the amount of the same component used to make the GL. For example, if the composition used to make the GL comprises 30 w/w % of a particular component, then preferably the composition used to make the optional PL layer comprises 27 to 33 w/w % (i.e. +/−10%), more preferably 28.5 w/w % to 31.5 w/w % (i.e. +/−5%), of that same component.

Alternatively the optional PL layer can be obtained from different components than the GL.

The GL and the optional protective layer are preferably each independently obtained from a curable composition comprising:
(1) 0.1 to 25 w/w % of the curable polysiloxane polymer;
(2) 0 to 5 w/w % of a photo-initiator;
(3) 70 to 99.5 w/w % of inert solvent; and
(4) 0.01 to 5 w/w % of metal complex;
wherein the composition has a molar ratio of metal: silicon of at least 0.0005.

Preferably the curable composition used to form the GL and/or PL (and the resultant GL and optional PL) has a molar ratio of metal: silicon of 0.001 to 0.1 or, more preferably, 0.003 to 0.03.

Preferably the curable composition used to form the GL and/or optional PL comprises 0.02 to 0.6 mmol (more preferably 0.03 to 0.3 mmol) of component (4) per gram of component (1).

Component (1) typically comprises at least one polymerisable group. Examples of polymerisable groups are as hereinbefore described.

The amount of component (1) present in the composition used to form the GL and/or PL is preferably 1 to 20 w/w %, more preferably 2 to 15 w/w %.

In a preferred embodiment, component (1) comprises a partially crosslinked, radiation-curable polymer comprising dialkylsiloxane groups.

Photo-initiators may be included in the composition used to form the GL and/or PL and are usually required when the curing uses UV radiation. Suitable photo-initiators are those known in the art such as radical type, cation type or anion type photo-initiators.

Cationic are preferred when a component of the composition used to form the GL and/or PL comprises curable groups such as epoxy, oxetane, other ring-opening heterocyclic groups or vinyl ether groups.

Preferred cationic photo-initiators include organic salts of non-nucleophilic anions, e.g. hexafluoroarsinate anion, antimony (V) hexafluoride anion, phosphorus hexafluoride anion, tetrafluoroborate anion and tetrakis (2,3,4,5,6-pentafluorophenyl)boranide anion. Commercially available cationic photo-initiators include UV-9380c, UV-9390c (manufactured by Momentive performance materials), UVI-6974, UVI-6970, UVI-6990 (manufactured by Union Carbide Corp.), CD-1010, CD-1011, CD-1012 (manufactured by Sartomer Corp.), Adekaoptomer™ SP-150, SP-151, SP-170, SP-171 (manufactured by Asahi Denka Kogyo Co., Ltd.), Irgacure™ 250, Irgacure™ 261 (Ciba Specialty Chemicals Corp.), CI-2481, CI-2624, CI-2639, CI-2064 (Nippon Soda Co., Ltd.), DTS-102, DTS-103, NAT-103, NDS-103, TPS-103, MDS-103, MPI-103, BBI-103 (Midori Chemical Co., Ltd.), Bis[4-n-alkyl(C10˜13)phenyl]iodonium tetrakispentafluorophenylborate (WPI-124 from WAKO), Bis[4-n-alkyl(C10˜13)phenyl]iodonium Hexafluorophosphate (WPI-113 from WAKO), Bis[4-n-alkyl(C10˜13)phenyl]iodonium Hexafluoroantimonate (WPI-116 from WAKO), Bis(4-tert-butylphenyl) iodium hexafluorophosphate (WPI-170 from WAKO) and 4-isopropyl-4′-methyldiphenyliodonium tetrakis(pentafluorophenyl) borate ((C₄₀H₁₈BF₂₀I) available under the name I0591 from TCI). The above mentioned cationic photo-initiators can be used either individually or in combination of two or more.

Radical Type I and/or type II photo-initiators may also be used when the curable group comprises an ethylenically unsaturated group, e.g. a (meth)acrylate or (meth) acrylamide.

Examples of radical type I photo-initiators are as described in WO 2007/018425, page 14, line 23 to page 15, line 26, which are incorporated herein by reference thereto.

Examples of radical type II photo-initiators are as described in WO 2007/018425, page 15, line 27 to page 16, line 27, which are incorporated herein by reference thereto.

The amount of component (2) is preferably 0.005 to 2 w/w %, more preferably 0.01 to 1 w/w %.

Preferably the weight ratio of component (2) to (1) is between 0.001 to 1 and 0.2 to 1, more preferably between 0.002 to 1 and 0.1 to 1. A single type of photo-initiator may be used but also a combination of several different types.

When no photo-initiator is included in the composition used to form the GL and/or PL, the composition can be advantageously cured by electron-beam exposure. Preferably the electron beam output is between 50 and 300 keV. Curing can also be achieved by plasma or corona exposure.

The function of the inert solvent (3) is to provide the composition used to form the GL and/or PL with a viscosity suitable for the particular method used to apply the curable composition to the underlying substrate. For high speed application processes one will usually choose an inert solvent of low viscosity. Examples of suitable inert solvents are mentioned above.

The amount of component (3) is preferably 70 to 99.5 w/w %, more preferably 80 to 99 w/w %, especially 90 to 98 w/w %.

Component (4) can provide the resultant GL or PL with a desired amount of metal.

The metal is preferably selected from the groups 2 to 16 of the periodic table (according the IUPAC format), including transition metals. Examples of such metals include: Be, Mg, Ca, Sr, Ba, Sc, Y, La, Ce, Pr, Nd, Pm, Sm, Eu, Gd, Tb, Dy, Ho, Er, Tm, Yb, Lu, Ti, Zr, Hf, V, Nb, Ta, Cr, Mo, W, Mn, Re, Fe, Ru, Os, Co, Rh, Ir, Ni, Pd, Pt, Cu, Zn, Cd, B, Al, Ga, In, TI, Si, Ge, Sn, Pb, As, Sb, Bi, Se, Te. More preferred are Mg, Ca, Sr, Ba, Sc, Y, La, Ce, Pr, Nd, Sm, Gd, Dy, Ho, Er, Tm, Yb, Ti, Zr, Hf, V, Nb, Ta, Cr, Mo, W, Mn, Fe, Ru, Co, Ir, Ni, Zn, B, Al, Ga, In, Si, Ge, Sn, As, Sb, Bi, Se and Te and mixtures comprising two or more thereof (the phrase “a metal” is not intended to be limited to just one metal and includes the possibility of two or more metals being present). Preferably the metal is not platinum.

From commercial availability point of view, metals from the groups 3, 4, 13 and/or 14 of the periodic table are preferred, more preferably Ti, Zr, Al, Ce and Sn, especially Ti, Zr and Al.

The metal preferably has a positive charge of at least two, more preferably the metal is trivalent (charge of 3⁺), tetravalent (charge of 4⁺) or pentavalent (charge of 5⁺).

The metal complex, when used, may also comprise two or more different metal ions, e.g. as in barium titanium alkoxide, barium yttrium alkoxide, barium zirconium alkoxide, aluminum yttrium alkoxide, aluminum zirconium alkoxide, aluminum titanium alkoxide, magnesium aluminum alkoxide and aluminum zirconium alkoxide,

The metal complex preferably comprises a metal (e.g. as described above) and a halide or an organic ligand, for example an organic ligand comprising one or more donor atoms which co-ordinate to the metal. Typical donor atoms are oxygen, nitrogen and sulphur, e.g. as found in hydroxyl, carboxyl, ester, amine, azo, heterocyclic, thiol, and thioalkyl groups.

The ligand(s) may be monodentate or multidentate (i.e. the ligand has two or more groups which co-ordinate with the metal).

In a particularly preferred embodiment the metal complex comprises a metal and an organic ligand comprising an alkoxide or an optionally substituted 2,4-pentanedionate group and/or a carboxyl group (e.g. a neodecanoate group).

The metal complex may also comprise one or more inorganic ligands, in addition to the organic ligand(s), and optionally one or more counterions to balance the charge on the metal. For example the metal complex may comprise a halide (e.g. chloride or bromide) or water ligand.

Preferably the metal complex has a coordination number of 2 to 6, more preferably 4 to 6 and especially 4 or 6.

Preferably the curable composition used to form the GL and/or PL comprises 0.01 to 5 w/w %, more preferably 0.01 to 2 w/w %, especially 0.02 to 1 w/w % of metal complex.

The curable composition used to form the GL and/or PL may contain other components, for example surfactants, surface tension modifiers, viscosity enhancing agents, biocides and/or other components capable of co-polymerisation with the other ingredients.

According to a second aspect of the present invention there is provided a process for preparing a GSM according to the first aspect of the present invention which comprises the steps of:
(i) forming a gutter layer (GL) of average thickness of less than 2.5 μm on a porous substrate; and
(ii) forming on the GL a discriminating layer (DL) comprising at least 60 w/w % of EO groups and at least 0.15 mmol/g of thioether groups, and having an average thickness greater than 0.2 μm and less than 5 μm; and
(iii) optionally forming on the DL a PL comprising a cross-linked polysiloxane polymer.

In a preferred embodiment the GL, DL and PL (when present) are formed by curing the relevant compositions described above for forming the GL, DL and optional PL respectively.

The compositions described above may be applied to the underlying porous substrate (e.g. the composition used to form the GL is applied to the porous substrate, the composition used to form the DL is applied to the GL and the composition used to form the PL (when present) is applied to the DL) by a coating process. Examples of coating processes include slot die coating, slide coating, knife coating, roller coating, screen-printing, spray coating, spin coating, and dip coating. Depending on the used technique and the desired end specifications, it might be necessary to remove excess composition from the underlying substrate by, for example, air knife, roll-to-roll squeeze, roll-to-blade or blade-to-roll squeeze, blade-to-blade squeeze or removal using coating bars.

Preferably the GSM of the present invention has a H₂S permeance >400 GPU, more preferably >500 GPU, most preferably >550 GPU, where GPU is defined as 1 cm³ (STP)/(cm²·cm Hg·s), where 1 cm Hg corresponds to 1333 Pa. Consequently 1 m³ (STP)/(m²·kPa·s) corresponds to 1.333·10⁸ GPU.

Preferably each composition used to prepare each layer (GL, DL and optional PL) is applied to the underlying substrate in a roll-to-roll process having high tension forces at unrolling and/or rolling the porous substrate of at least 50 N/m. In even more preferred process the tension forces of unrolling or rolling the substrate are at least 100 N/m.

The compositions used to form each layer (GL, DL and optional PL) are preferably radiation-curable.

Suitable sources of radiation include mercury arc lamps, carbon arc lamps, low pressure mercury lamps, medium pressure mercury lamps, high pressure mercury lamps, swirl flow plasma arc lamps, metal halide lamps, xenon lamps, tungsten lamps, halogen lamps, lasers and ultraviolet light emitting diodes. Particularly preferred are UV emitting lamps of the medium or high pressure mercury vapor type. In addition, additives such as metal halides may be present to modify the emission spectrum of the lamp. In most cases lamps with emission maxima between 200 and 450 nm are particularly suitable.

The energy output of the irradiation source is preferably from 20 to 1000 W/cm, preferably from 40 to 500 W/cm but may be higher or lower as long as the desired exposure dose can be realized.

Irradiation in order to cure the compositions used to prepare the layers (GL, DL and optional PL) may be performed once or more than once.

In order to produce sufficiently flowable compositions for use in a high speed coating machine, the compositions used to form each layer preferably has a viscosity below 4000 mPa·s when measured at 25° C., more preferably from 0.4 to 1000 mPa·s when measured at 25° C. Most preferably the viscosity of the compositions is from 0.4 to 500 mPa's when measured at 25° C. For coating methods such as slide bead coating the preferred viscosity is from 1 to 100 mPa·s when measured at 25° C. The desired viscosity is preferably achieved by controlling the amount of inert solvent in the compositions and/or by appropriate selection of the components of the compositions and their amounts.

With suitable coating techniques, coating speeds of at least 5 m/min, e.g. at least 10 m/min or even higher, such as 15 m/min, 20 m/min, 25 m/min or even up to 100 m/min, can be reached. In a preferred embodiment the compositions used to form each layer are applied to the underlying substrate at a coating speed as described above.

While it is possible to prepare the GSMs of the present invention on a batch basis with a stationary porous substrate, it is much preferred to prepare them on a continuous basis using a moving porous substrate, e.g. the porous substrate may be in the form of a roll which is unwound continuously, or the porous substrate may rest on a continuously driven belt. Using such techniques the compositions used to form each layer can be applied on a continuous basis or can be applied on a large batch basis. Removal of any inert solvent present in each composition can be accomplished at any stage after the composition has been applied to the porous substrate, e.g. by evaporation or drying.

Thus in a preferred process for making the GSMs of the present invention, the compositions used to form each layer are applied continuously to the underlying substrate by means of a manufacturing unit comprising one or more composition application stations, one or more curing stations and a GSM collecting station, wherein the manufacturing unit comprises a means for moving the porous substrate from the first to the last station (e.g. a set of motor driven pass rollers guiding the substrate through the coating line). The unit optionally further comprises one or more drying stations or IR-heating stations, e.g. for drying the final GSM.

The GSM of the present invention is preferably in tubular form or, more preferably, in sheet form. Tubular forms of GSMs are sometimes referred to as being of the hollow fibre type. GSMs in sheet form are suitable for use in, for example, spiral-wound, plate-and-frame and envelope cartridges.

While this specification emphasises the usefulness of the GSMs of the present invention for separating gases, especially polar and non-polar gases, it will be understood that the GSMs can also be used for other purposes, for example providing a reducing gas for the direct reduction of iron ore in the steel production industry, dehydration of organic solvents (e.g. ethanol dehydration), pervaporation, oxygen enrichment, solvent resistant nanofiltration and vapor separation.

The GSMs of the present invention are particularly suitable for separating a feed gas containing a target gas into a gas stream rich in the target gas and a gas stream depleted in the target gas. For example, a feed gas comprising polar and non-polar gases may be separated into a gas stream rich in polar gases and a gas stream depleted in polar gases. In many cases the GSMs have a high permeability to polar gases, e.g. CO₂, H₂S, NH₃, SOₓ, and nitrogen oxides, especially NOx, relative to non-polar gases, e.g. hydrocarbons, H₂ and N₂.

The target gas may be, for example, a gas which has value to the user of the GSM and which the user wishes to collect. Alternatively the target gas may be an undesirable gas, e.g. a pollutant or ‘greenhouse gas’, which the user wishes to separate from a gas stream in order to meet a product specification or to protect the environment.

Preferably the GSM of the present invention is gas permeable and liquid impermeable.

According to a third aspect of the present invention there is provided a process for separating a feed gas comprising polar and non-polar gases into a gas stream rich in polar gases and a gas stream depleted in polar gases, the process comprising bringing the feed gas into contact with a GSM according to the first aspect of the present invention.

In the process according to the third aspect of the present invention, typically a part of the feed gas passes through the GSM to give a permeate gas and a part of the feed gas is retained by the GSM to give a retentate gas and the process comprises the step of collecting the permeate gas and/or the retentate gas.

According to a fourth aspect of the present invention there is provided a gas-separation module comprising a GSM according to the first aspect of the present invention.

In the modules of the fourth aspect of the present invention the GSM is preferably in the form of a flat sheet, a spiral-wound sheet or takes the form of a hollow-fiber membrane.

Thus the GSMs and modules of the present invention may be used for the separation of gases and/or for the purification of a feed gas(es).

The invention will now be illustrated by the following non-limiting Examples in which all parts and percentages are by weight unless specified otherwise.

The following materials were used in the Examples (all without further purification):
UV-9300 is α, ω-(trimethylsiloxy)-poly-[(epoxycyclohexylethyl)methylsiloxane-co-dimethylsiloxane] from Momentive Performance Materials GmbH.
UV-9315 is α, ω-((epoxycyclohexylethyl)dimethyl)-poly-[(epoxycyclohexylethyl)methylsiloxane-co-dimethylsiloxane] from Momentive Performance Materials GmbH.
X-22-162C is α, ω-(2-carboxyethyl-dimethylsiloxy)-polydimethylsiloxane from Shin-Etsu Chemical Co., Ltd.
n-Heptane is n-Heptane from Brenntag Nederland B.V.
DBU is 1,8-Diazabicyclo[5.4.0]undec-7-ene from Merck Life Science N.V.
TPT is Titanium (IV) isopropoxide from Merck Life Science N.V.
MEK is 2-butanone from Brenntag Nederland B.V.
I0591 is 4-isopropyl-4′-methyldiphenyliodonium Tetrakis (pentafluorophenyl) borate from TCI Europe N.V.
A-BPE30 is ethoxylated bisphenol A diacrylate from Shin Nakamura Chemical Co., Ltd., having the following structure, where the average (m+n) is 30.

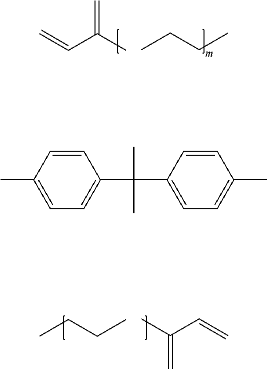

TC-340 is Thiocure 340, Pentaerythritol tetrakis(3-mercaptopropionate) from Brenntag Nederland B.V.
TC-360 is Thiocure 360, Dipentaerythritol hexakis (3-mercaptopropionate) from Brenntag Nederland B.V.
TC-333 is Thiocure 333, Ethoxylated trimethylolpropane tris(3-mercapto propionate) from Brenntag Nederland B.V.
MDPP is Methyl (diphenyl)phosphine from Merck Life Science N.V.
EO-2SH is 2,2′-(Ethylenedioxy) diethanethiol from Merck Life Science N.V.
PEGDA is poly(ethyleneglycol)diacrylate (a crosslinking agent), having an average Mn of 700 g/mol from Merck Life Science N.V.
PEG2000DA is poly(ethyleneglycol)diacrylate (a crosslinking agent), having an average Mn of 2000 g/mol from Merck Life Science N.V.
BYK is BYK-UV 3530, a polyether modified acryl functional polydimethylsiloxane from BYK-Chemie GmbH.
O-1173 is 2-Hydroxy-2-methyl-1-phenylpropanone (a photoinitiator) from IGM Resins B.V.
PAN is a porous polyacrylonitrile substrate comprising a PET non-woven backing from Microdyn-Nadir GmbH.
MIBK is methylisobutyl ketone from Brenntag Nederland B.V.
DIOX is 1,3-dioxolane from Brenntag Nederland B.V.
APTMS is 3-trimethoxysilyl propan-1-amine from Merck Life Science N.V.
TMSPAC is 3-(trimethoxysilyl) propylacrylate from Gelest Inc.
ETOAC is ethyl acetate from Merck Life Science N.V.
PI1 is 6FDA-DATMBSAₘ/DABAₙ, m/n=90/10; obtained from FUJIFILM Corporation, having the following structure:

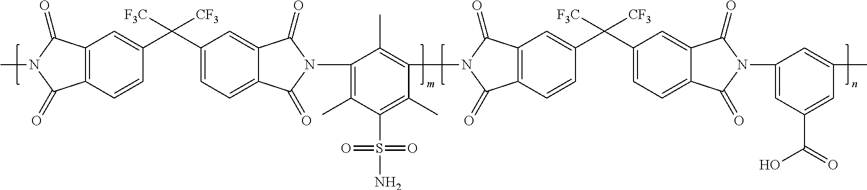

The performance of the GSMs of the present invention and Comparative GSMs were evaluated using the following tests:

### Gas Permeance and Selectivity

The GSM under test was placed into a cell and the feed gas having a composition of CO₂/CH₄/n-C₄H₁₀/N₂ of 13.0/79.0/0.5/7.0 by volume was passed through the GSM at 40° C. at a gas feed pressure of 4000 kPa. The permeance of CO₂, n-C₄H₁₀, CH₄ and N₂ through the GSM was measured using a gas permeation cell with a measurement diameter of 2.0 cm.

The permeance (Qi) of CO₂, n-C₄H₁₀, CH₄ and N₂ was determined after 5 minutes continuous use on gas separation composites using the following equation:

$${Q}_{i} = ( {θ}_{Perm} \cdot {X}_{Perm , i} ) / ( A \cdot ( {P}_{Feed} \cdot {X}_{Feed , i} - {P}_{Perm} \cdot {X}_{Perm , i} ) )$$

wherein:
Qᵢ=Permeance of each gas (i.e. i denotes CO₂ or n-C₄H₁₀ or CH₄ or N₂)
(m³ (STP)/(m²·kPa·s));
θ_{Perm}=Permeate flow rate (m³ (STP)/s);
X_{Perm,i}=Volume fraction of the relevant gas in the permeate gas;
A=GSM area (m²);
P_{Feed}=Feed gas pressure (kPa);
X_{Feed,i}=Volume fraction of the relevant gas in the feed gas;
P_{Perm}=Permeate gas pressure (kPa); and
STP is standard temperature and pressure, which is defined here as 25.0° C. and 1 atmosphere pressure (101.325 kPa).

The permeance results were converted to the GPU unit, which is defined as 1 cm³ (STP)/(cm²·cmHg·s), where 1 cmHg corresponds to 1333 Pa. Consequently 1 m³ (STP)/(m²·kPa·s) corresponds to 1.333·10⁸ GPU.

The CO₂ over N₂ selectivity of each GSM was calculated according:

$$α {CO}_{2} / {N}_{2} = Q {CO}_{2} / Q {N}_{2}$$

wherein QCO₂, and QN₂ were determined by the method described above and
αCO₂/N₂=Selectivity of carbon dioxide over nitrogen.

A selectivity for carbon dioxide over nitrogen of 15 or above was regarded as acceptable. Preferably however the selectivity for carbon dioxide over nitrogen was at least 17 with higher values being even better. A selectivity for carbon dioxide over nitrogen of below 15 was regarded as not acceptable.

The hydrogen sulfide permeance and hydrogen sulfide over methane selectivity of the GSMs were determined in a similar manner from permeation tests performed using feed gas having a composition of CO₂/CH₄/N₂/H₂S of 31.73/37.85/2/3.23/0.05 by volume at 56° C. and at a gas feed pressure of 3200 kPa.

A selectivity for hydrogen sulfide over methane (CH₂S/CH₄) of 18 was regarded as acceptable with higher values being even better. A selectivity for hydrogen sulfide over methane of below 18 was regarded as not acceptable.

A hydrogen sulfide permeance of 400 GPU or above was regarded as acceptable. A hydrogen sulfide permeance of below 400 GPU was regarded as not acceptable.

### Ageing Stability Test

The ageing stability test was performed by measuring the selectivity for CO₂ over N₂ selectivity according to the method described above (S1), then storing the GSM under test at 40° C. and 90% relative humidity for 6 weeks and measuring the selectivity for CO₂ over N₂ once again in an identical manner (S2). Ageing stability was regarded as being good if the selectivity for CO₂ over N₂ (S2 vs. S1) dropped by 15% or less over the 6 weeks. Ageing stability was regarded as being bad if the selectivity for CO₂ over N₂ (S2 vs. S1) dropped more than 15% over the 6 weeks.

Determination of EO content of the GSM

The EO content of the GSMs was determined by digesting 12.57 cm² of the GSM in 2 ml of 1 mol/l deuterated sodium hydroxide in deuterated water at 60° C. for 16 hours. The obtained digestate was then filtered over a 0.05 μm filter. Subsequently 10 mg of calcium formate internal reference was added to 600 mg digestate and the resultant solution was analysed by ¹H-NMR to quantify the EO content.

### Determination of EO Content of the DL

The EO content of the DL was calculated by dividing the EO content of the GSM by the average thickness of the DL. The average thickness of the DL was determined by cutting through the GSM and examining the cross section of the GSM, and in particular the DL within the GSM, by SEM.

### Determination of Sulphur Content of the GSM

The sulphur content of the GSM (S_{GSM}) was determined by by means of microwave digestion. The digested solutions were diluted up to 50 ml with milli-Q water and sulphur amount was determined using ICP-OES. In an analogous manner, the sulphur content of the used porous substrate comprising the gutter layer (when a gutter layer was present in the GSM) (S_{SUB}) was determined.

### Determination of Sulphur Content of the DL

The sulphur content of the DL (SDL) was calculated using the following equation:

$${S}_{DL} = ( {S}_{GSM} - {S}_{SUB} ) / {d}_{DL}$$

Wherein d_{DL} is the average thickness of the DL, which was determined by cutting through the membrane and examining its cross section by SEM.

### Determination of Thioether Content of the DL

The thioether content of the DL (TE_{DL}) was calculated from the composition, assuming that when vinylic and/or acrylic groups are present in excess or higher amounts vs. thiol groups, then all thiol groups are reacted to thioether groups. In case thiol groups are present in excess or higher amounts vs. vinylic and/or acrylic groups in the composition, then it is assumed that all vinylic and/or acrylic groups are reacted to thioether groups.

Alternatively, the DL thioether content (TE_{DL}) of an unknown GSM sample can be determined via the following method.
1) digesting 12.57 cm² of GSM sample in 10 ml concentrated nitric acid by means of microwave digestion; and
(2) diluting the digested solutions up to 50 ml with milli-Q water; and
(3) determining the sulphur content using ICP-OES; and
(4) in an analogous way determining the sulphur content of the porous substrate
(5) subtracting the sulphur content of the substrate from the sulphur content of the GSM to find the sulphur content of the discriminating layer; and
(6) calculating the thioether content of the discriminating layer according to the formula below by dividing the sulphur content by the molecular weight of sulphur.

$${TE}_{DL} = {S}_{DL} / {M}_{w} ( S )$$

Wherein M_{W}(S) is the molecular weight of sulphur (32.065 g/mol).

### EXAMPLES

### Preparation of the Compositions GLC1 to GLC7 Used to Form the Gutter Layers

### GLC1:

In a 20 I glass, double walled, reaction vessel equipped with a high efficiency condenser the following components were mixed at room temperature:
7462.3 g UV-9300
2136.3 g X-22-162C
6400.0 g n-Heptane
1.389 ml DBU

Subsequently nitrogen gas was purged through the solution under continuous mixing for several hours to eliminate oxygen. Next the nitrogen purging through the solution was stopped and replaced by nitrogen purging over the solution and the solution was heated to 91.0° C. and kept at that temperature under continuous mixing until the viscosity, measured at 25.0° C. and 15.84 s⁻¹ was 125 mPa·s, after which the solution was cooled down under continuous mixing to 20.0° C.

### GLC2 and GLC3:

In a brown PE bottle the following components indicated in Table 1 were mixed for 64 hours at room temperature:

TABLE 1
Composition GLC2 and GLC3:

| | | |
|---|---|---|
| Component | GLC2 | GLC3 |

| | | | | |
|---|---|---|---|---|
| GLC1 | 16.667 | g | 25.000 | g |
| n-Heptane | 80.994 | g | 71.491 | g |
| TPT | 0.225 | g | 0.338 | g |

### GLC4 to GLC7:

In a brown PE bottle the following components indicated in Table 2 were mixed for 5 minutes at room temperature:

TABLE 2
Composition GLC4 to GLC7:

| Component | GLC4 | | GLC5 | | GLC6 | | GLC7 | |
|---|---|---|---|---|---|---|---|---|
| GLC2 | 4.894 | g | 48.943 | g | 97.886 | g | 0 | g |
| GLC3 | 0 | g | 0 | g | 0 | g | 96.829 | g |
| n-Heptane | 92.991 | g | 48.943 | g | 0 | g | 0 | g |
| MEK | 2.009 | g | 1.057 | g | 0 | g | 0 | g |
| 5 w/w % | 0.106 | g | 1.057 | g | 2.114 | g | 3.171 | g |
| solution | | | | | | | | |
| of I0591 | | | | | | | | |
| in MEK | | | | | | | | |

After preparation, the compositions described in Table 2 were filtered through a 0.6 μm polypropylene filter to give GLC4 to GLC7.

### Preparation of the Gutter Layer Composites GL1 to GL9

As indicated in Table 3 below, gutter layer composites GL1 to GL9 were prepared by applying the gutter layer compositions GLC1 to GLC7 to a porous substrate (PAN) by pre-metered slot die coating at a coating speed of 10 m/min and a web tension of 275 N/m at room temperature. Subsequent drying at 30° C. and then curing by exposure to UV light at an intensity of 23.5 kW/m using a Light Hammer LH10 from Fusion UV Systems fitted with a H-bulb resulted in gutter layer composites GL1 to GL9.

TABLE 3
Preparation of Gutter Layer Composites

| | | | Average |
|---|---|---|---|
| | | | thickness of |
| | | | gutter layer |
| Gutter layer | Porous | Gutter layer | above the porous |
| composite | substrate | composition | substrate (nm) |
| GL1 | PAN | GLC4 | 18 |
| GL2 | PAN | GLC4 | 42 |
| GL3 | PAN | GLC5 | 65 |
| GL4 | PAN | GLC5 | 112 |
| GL5 | PAN | GLC5 | 175 |
| GL6 | PAN | GLC6 | 585 |
| GL7 | PAN | GLC7 | 2600 |
| (comparative) | | | |
| GL8 | PAN | GLC7 | 4930 |
| (comparative) | | | |
| GL9 | PAN | GLC7 | 6150 |
| (Comparative) | | | |

The average thicknesses of the GLs mentioned in Table 3 above were determined by cutting through the gutter layer composite and examining its cross section by SEM. The part of the GL which was present within the pores of the porous substrate was not taken into account.

Preparation of the Discriminating Layer Compositions DLC1 to DLC13 Discriminating layer compositions (DLCs) were prepared having the formulations shown in Table 4 below:

### DP1:

In a 4 I glass, double walled, reaction vessel equipped with a high efficiency condenser the following components were mixed at room temperature:
788.79 g A-BPE30
1998.73 g MEK
0.476 ml DBU

Subsequently 736.72 ml of a 10.00 w/w % solution of TC-340 in MEK was slowly added over a period of 45 minutes under continuous mixing after which the solution was heated to 60° C. for 16 hours after which it was cooled down to 20° C.

### DP2:

In a 4 I glass, reaction vessel the following components were mixed at room temperature:
936.40 g A-BPE30
63.60 g TC-340
3000.00 g ETOAC

Subsequently 4.00 ml MDPP was added under continuous mixing, after which the solution was mixed for 40 hours.

### DP3:

In a 100 ml glass bottle the following components were mixed at room temperature:
18.063 g A-BPE30
2.789 g TC-333
0.398 g EO-2SH
63.665 g ETOAC

Subsequently 79.0 μl MDPP was added under continuous mixing, after which the solution was mixed for 40 hours.

### DP4:

In a 100 ml glass bottle the following components were mixed at room temperature:
19.658 g PEG2000DA
1.671 g TC-340
63.665 g ETOAC

Subsequently 79.0 μl MDPP was added under continuous mixing, after which the solution was mixed for 40 hours.

### DP5:

In a 100 ml glass bottle the following components were mixed at room temperature:
20.238 g A-BPE30
1.012 g TC-340
63.665 g ETOAC

Subsequently 79.0 μl MDPP was added under continuous mixing, after which the solution was mixed for 40 hours.

### DP6:

In a 100 ml glass bottle the following components were mixed at room temperature:
20.433 g A-BPE30
0.817 g TC-360
63.665 g ETOAC

Subsequently 79.0 μl MDPP was added under continuous mixing, after which the solution was mixed for 40 hours.

### DP7:

In a 100 ml glass bottle the following components were mixed at room temperature:
20.732 g A-BPE30
0.518 g TC-360
63.665 g ETOAC

Subsequently 79.0 μl MDPP was added under continuous mixing, after which the solution was mixed for 40 hours.

Discriminating layer compositions DLC1 to DLC 13 were then prepared by mixing the components indicated in Table 4 below at room temperature and subsequently filtering the compositions through a 0.6 μm polypropylene filter.

TABLE 4
Discriminating layer compositions (all amounts are in w/w %)

| | | | | | | | | | | DLC | DLC | DLC | DLC |
|---|---|---|---|---|---|---|---|---|---|---|---|---|---|
| | DLC1 | DLC2 | DLC3 | DLC4 | DLC5 | DLC6 | DLC7 | DLC8 | DLC9 | 10 | 11 | 12 | 13 |
| Solids | 8.468 | 8.309 | 8.468 | 2.823 | 0.847 | 6.120 | 12.702 | 1.01 | 9.059 | 6.120 | 6.120 | 6.120 | 6.120 |
| content | | | | | | | | | | | | | |
| (w/w %) | | | | | | | | | | | | | |
| EO* | 69.457 | 70.787 | 69.457 | 69.457 | 69.457 | 65.340 | 77.148 | 0 | 64.922 | 79.788 | 70.138 | 70.812 | 71.848 |
| (w/w % vs. | | | | | | | | | | | | | |
| solid) | | | | | | | | | | | | | |
| DP1 | 31.804 | | | | | | | | 31.804 | | | | |
| DP2 | | 31.804 | 31.804 | 10.601 | 3.180 | | | | | | | | |
| DP3 | | | | | | 22.986 | | | | | | | |
| DP4 | | | | | | | | | | 22.986 | | | |
| DP5 | | | | | | | | | | | 22.986 | | |
| DP6 | | | | | | | | | | | | 22.986 | |
| DP7 | | | | | | | | | | | | | 22.986 |
| PEGDA | | | | | | | 11.927 | | | | | | |
| TC-340 | | | | | | | | | 0.591 | | | | |
| PI1 | | | | | | | | 1.000 | | | | | |
| MEK | 67.679 | 67.838 | 67.679 | 89.226 | 96.768 | 76.640 | 87.297 | 91.000 | 67.088 | 76.640 | 76.640 | 76.640 | 76.640 |
| MIBK | | | | | | | | 3.000 | | | | | |
| DIOX | | | | | | | | 4.990 | | | | | |
| BYK | 0.199 | 0.199 | 0.199 | 0.066 | 0.020 | 0.144 | 0.298 | | 0.199 | 0.144 | 0.144 | 0.144 | 0.144 |
| O-1173 | 0.159 | 0.159 | 0.159 | 0.053 | 0.016 | 0.115 | 0.239 | | 0.159 | 0.115 | 0.115 | 0.115 | 0.115 |
| APTMS | | | | | | | | 0.010 | | | | | |
| TMSPAC | 0.159 | | 0.159 | 0.053 | 0.016 | 0.115 | 0.239 | | 0.159 | 0.115 | 0.115 | 0.115 | 0.115 |

*In Table 4, EO means the w/w % of ethylene oxide groups relative to the total weight of solids in the relevant composition (i.e. including all ingredients of the composition except for solvents).

### Forming Gas Separation Membranes GSM1 to GSM29

The gutter layer composites GL1 to GL9, prepared as described above, were exposed to a corona discharge of 0.285 J/cm² directly before the application of the discriminating layer compositions, as indicated in Table 5 below.

Using a pre-metered slot die coating, the discriminating layer compositions DLC 1 to DLC13 were applied to the gutter layer composites GL1 to GL9 which had been treated to the corona discharge, or to PAN substrate only (lacking a gutter layer, therefore a Comparative Example, also lacking a corona discharge treatment) as indicated in Table 5 below. The discriminating layer compositions were applied at a coating speed of 10 m/min and a web tension of 275 N/m and the coated substrates were subsequently dried at 30° C.

As indicated in Table 5 below, all but one of the DLCs present on a substrate were cured by exposure to UV light at an intensity of 23.5 kW/m using a Light Hammer LH10 from Fusion UV Systems fitted with a H-bulb directly after the drying.

The penultimate column of Table 5 shows the calculated w/w % of ethylene oxide (EO) groups present in the resultant discriminating layer.

In Table 5 the “Applied DLC amount” was calculated from the applied amount of discriminating layer composition and the density of the components thereof.

TABLE 5
Preparation of Gas Separation Membranes GSM1 to GSM29, not comprising a Protective Layer

| | | | | | Applied DLC | | | |
|---|---|---|---|---|---|---|---|---|
| | | | Substrate | | amount (μm, | | DL EO | |
| | | | corona | | excluding inert | DL UV | content | Resultant |
| Example | DL | Substrate | treatment? | DLC | solvents) | curing? | (w/w %) | GSM |
| 1 (Comp.) | DL1 | GL6 | Yes | DLC8 | 0.09 | No | 0.0 | GSM1 |
| | | | | | | | | (Comp.) |
| 2 (Comp.) | DL2 | PAN | No | DLC2 | 1.75 | Yes | 70.8 | GSM2 |
| | | | | | | | | (Comp.) |
| 3 (Comp.) | DL3 | PAN | No | DLC2 | 1.25 | Yes | 70.8 | GSM3 |
| | | | | | | | | (Comp.) |
| 4 (Comp.) | DL4 | PAN | No | DLC2 | 1.00 | Yes | 70.8 | GSM4 |
| | | | | | | | | (Comp.) |
| 5 | DL5 | GL1 | Yes | DLC3 | 1.75 | Yes | 69.5 | GSM5 |
| 6 | DL6 | GL2 | Yes | DLC3 | 1.75 | Yes | 69.5 | GSM6 |
| 7 | DL7 | GL3 | Yes | DLC3 | 1.75 | Yes | 69.5 | GSM7 |
| 8 | DL8 | GL4 | Yes | DLC3 | 1.75 | Yes | 69.5 | GSM8 |
| 9 | DL9 | GL4 | Yes | DLC3 | 1.25 | Yes | 69.5 | GSM9 |
| 10 | DL10 | GL4 | Yes | DLC3 | 1.00 | Yes | 69.5 | GSM10 |
| 11 | DL11 | GL4 | Yes | DLC4 | 0.75 | Yes | 69.5 | GSM11 |
| 12 | DL12 | GL4 | Yes | DLC4 | 0.50 | Yes | 69.5 | GSM12 |
| 13 | DL13 | GL4 | Yes | DLC4 | 0.35 | Yes | 69.5 | GSM13 |
| 14 (Comp.) | DL14 | GL5 | Yes | DLC5 | 0.20 (Comp.) | Yes | 69.5 | GSM14 |
| | | | | | | | | (Comp.) |
| 15 (Comp.) | DL15 | GL5 | Yes | DLC5 | 0.10 (Comp.) | Yes | 69.5 | GSM15 |
| | | | | | | | | (Comp.) |
| 16 | DL16 | GL4 | Yes | DLC1 | 1.75 | Yes | 69.5 | GSM16 |
| 17 | DL17 | GL4 | Yes | DLC6 | 1.75 | Yes | 68.8 | GSM17 |
| 18 | DL18 | GL4 | Yes | DLC7 | 1.75 | Yes | 77.1 | GSM18 |
| 19 | DL19 | GL5 | Yes | DLC3 | 1.75 | Yes | 69.5 | GSM19 |
| 20 (Comp.) | DL20 | GL7 | Yes | DLC3 | 1.75 | Yes | 69.5 | GSM20 |
| | | (Comp.) | | | | | | (Comp.) |
| 21 (Comp.) | DL21 | GL8 | Yes | DLC3 | 1.75 | Yes | 69.5 | GSM21 |
| | | (Comp.) | | | | | | (Comp.) |
| 22 (Comp.) | DL22 | GL9 | Yes | DLC3 | 1.75 | Yes | 69.5 | GSM22 |
| | | (Comp.) | | | | | | (Comp.) |
| 23 | DL23 | GL4 | Yes | DLC9 | 1.75 | Yes | 64.9 | GSM23 |
| 24 (Comp.) | DL24 | GL4 | Yes | DLC3 | 30.00 (Comp.) | Yes | 69.5 | GSM24 |
| | | | | | | | | (Comp.) |
| 25 (Comp.) | DL25 | GL4 | Yes | DLC3 | 45.00 (Comp.) | Yes | 69.5 | GSM25 |
| | | | | | | | | (Comp.) |
| 26 | DL26 | GL4 | Yes | DLC10 | 1.75 | Yes | 79.8 | GSM26 |
| 27 | DL27 | GL4 | Yes | DLC11 | 1.75 | Yes | 70.1 | GSM27 |
| 28 | DL28 | GL4 | Yes | DLC12 | 1.75 | Yes | 70.8 | GSM28 |
| 29 | DL29 | GL4 | Yes | DLC13 | 1.75 | Yes | 71.8 | GSM29 |

Note:
Comp. means Comparative

### Preparation of a Protective Layer Composition:

Protective layer composition PLC1 was prepared as follows: In a brown PE bottle the following components were mixed at room temperature:
5.000 g UV-9300
5.000 g UV-9315
82.489 g n-Heptane
2.000 g MEK
0.225 g TPT

Subsequently 5.286 g of a 5 w/w % solution of I0591 in MEK was added under continuous mixing to give protective layer composition PLC1.

### Preparation of the Gas Separation Membranes GSM30 to GSM 54 Comprising a Protective Layer

Using a pre-metered slot die coating, the protective layer composition PLC1 was applied to the unprotected GSMs indicated in Table 6, column 2, at a coating speed of 10 m/min and a web tension of 275 N/m at room temperature and subsequently dried at 30° C., immediately followed by exposure to UV light at an intensity of 23.5 kW/m using a Light Hammer LH10 from Fusion UV Systems fitted with a H-bulb directly after the drying.

TABLE 6
GSMs Comprising a Protective Layer

| | | Applied PLC1 | |
|---|---|---|---|
| | | amount (μm, | Resultant |
| | Starting GSM | excluding inert | (protected) |
| Example | (no PL) | solvents) | GSM |
| 30 | GSM1 (Comp.) | 1.20 | GSM30 (Comp.) |
| 31 | GSM19 | 1.20 | GSM31 |
| 32 | GSM20 | 1.20 | GSM32 |
| 33 | GSM8 | 1.20 | GSM33 |
| 34 | GSM9 (Comp.) | 1.20 | GSM34 (Comp.) |
| 35 | GSM10 | 1.20 | GSM35 |
| 36 | GSM11 | 1.20 | GSM36 |
| 37 | GSM12 | 1.20 | GSM37 |
| 38 | GSM13 | 1.20 | GSM38 |
| 39 | GSM14 (Comp.) | 1.20 | GSM39 (Comp.) |
| 40 | GSM15 (Comp.) | 1.20 | GSM40 (Comp.) |
| 41 | GSM16 | 1.20 | GSM41 |
| 42 | GSM23 | 1.20 | GSM42 |
| 43 | GSM5 | 1.20 | GSM43 |
| 44 | GSM6 | 1.20 | GSM44 |
| 45 | GSM7 | 1.20 | GSM45 |
| 46 | GSM18 | 1.20 | GSM46 |
| 47 | GSM21 (Comp.) | 1.20 | GSM47 (Comp.) |
| 48 | GSM22 (Comp.) | 1.20 | GSM48 (Comp.) |
| 49 | GSM24 (Comp.) | 1.20 | GSM49 (Comp.) |
| 50 | GSM25 (Comp.) | 1.20 | GSM50 (Comp.) |
| 51 | GSM26 | 1.20 | GSM51 |
| 52 | GSM27 | 1.20 | GSM52 |
| 53 | GSM28 | 1.20 | GSM53 |
| 54 | GSM29 | 1.20 | GSM54 |

Note:
Comp. means Comparative

The applied PLC1 amount mentioned in Table 7 above was calculated from the applied amount of protective layer composition, its composition and the density of the components of PLC1. 5

### Evaluation of the Gas Separation Membranes (GSMs)

The GSMs were evaluated as described above and the results are shown in Table 7 below, wherein Comp. indicates a comparative example.

TABLE 7
Results

| | | | | | Applied | | | | |
|---|---|---|---|---|---|---|---|---|---|
| | | | | Applied DL | PLC | | | | |
| | | | | amount | amount | | | | |
| | Average | | DL | (μm, | (μm, | | | | |
| | GL | DL EO | Thioether | excluding | excluding | | | | |
| | thickness | content | content | inert | inert | | Ageing | Q_{H2S} | |
| GSM | (nm) | (w/w %) | (mmol/g) | solvents) | solvents) | α_{CO2/N2} | stability | (GPU) | α_{H2S/CH4} |
| GSM30 | 585 | 0.0 | 0.000 | 0.09 | 1.20 | 19.5 | N/A | 12.5 | 16.9 |
| (Comp.) | | | | | | | | | |
| GSM31 | 175 | 69.5 | 0.489 | 1.75 | 1.20 | 27.5 | −5.0% | 685.1 | 37.0 |
| GSM32 | 2600 | 69.5 | 0.489 | 1.75 | 1.20 | 23.3 | +4.4% | 343.4 | 21.4 |
| (Comp.) | | | | | | | | | |
| GSM33 | 112 | 69.5 | 0.489 | 1.75 | 1.20 | 25.8 | −2.7% | 611.0 | 34.0 |
| GSM34 | 112 | 69.5 | 0.489 | 1.25 | 1.20 | 23.9 | +3.9% | 757.2 | 33.7 |
| GSM35 | 112 | 69.5 | 0.489 | 1.00 | 1.20 | 24.5 | −7.0% | 922.4 | 33.9 |
| GSM36 | 112 | 69.5 | 0.489 | 0.75 | 1.20 | 21.5 | −4.9% | 1213.0 | 30.1 |
| GSM37 | 112 | 69.5 | 0.489 | 0.50 | 1.20 | 21.3 | −6.2% | 1365.0 | 27.7 |
| GSM38 | 112 | 69.5 | 0.489 | 0.35 | 1.20 | 19.1 | −3.5% | 1438.5 | 26.7 |
| GSM39 | 175 | 69.5 | 0.489 | 0.20 | 1.20 | 7.1 | N/A | N/A | N/A |
| (Comp.) | | | | | | | | | |
| GSM40 | 175 | 69.5 | 0.489 | 0.10 | 1.20 | 6.8 | N/A | N/A | N/A |
| (Comp.) | | | | | | | | | |
| GSM41 | 112 | 69.5 | 0.489 | 1.75 | 1.20 | 27.9 | −8.3% | 566.1 | 32.9 |
| GSM42 | 112 | 64.9 | 0.991 | 1.75 | 1.20 | 28.9 | −2.7% | 470.2 | 37.9 |
| GSM43 | 18 | 69.5 | 0.489 | 1.75 | 1.20 | 23.0 | +11.3% | 557.1 | 30.0 |
| GSM44 | 42 | 69.5 | 0.489 | 1.75 | 1.20 | 21.6 | +3.8% | 680.8 | 27.3 |
| GSM45 | 65 | 69.5 | 0.489 | 1.75 | 1.20 | 22.7 | +7.2% | 605.8 | 30.7 |
| GSM46 | 112 | 77.1 | 0.000 | 1.75 | 1.20 | 15.3 | −6.5% | 1933.2 | 17.1 |
| (Comp.) | | | | | | | | | |
| GSM47 | 4930 | 69.5 | 0.489 | 1.75 | 1.20 | 18.2 | +3.5% | 243.6 | 17.6 |
| (Comp.) | | | | | | | | | |
| GSM48 | 6150 | 69.5 | 0.489 | 1.75 | 1.20 | 13.6 | N/A | 212.8 | 16.0 |
| (Comp.) | | | | | | | | | |
| GSM49 | 112 | 69.5 | 0.489 | 30.00 | 1.20 | 25.8 | −1.8% | 41.6 | 34.1 |
| (Comp.) | | | | | | | | | |
| GSM50 | 112 | 69.5 | 0.489 | 45.00 | 1.20 | 25.8 | N/A | 26.6 | 34.9 |
| (Comp.) | | | | | | | | | |
| GSM51 | 112 | 80.4 | 0.601 | 1.75 | 1.20 | 24.8 | −2.5% | 523.5 | 33.2 |
| GSM52 | 112 | 70.1 | 0.382 | 1.75 | 1.20 | 23.6 | −1.9% | 561.6 | 32.8 |
| GSM53 | 112 | 70.8 | 0.293 | 1.75 | 1.20 | 24.2 | −4.8% | 570.9 | 31.9 |
| GSM54 | 112 | 71.8 | 0.178 | 1.75 | 1.20 | 24.5 | −3.6% | 595.5 | 33.0 |
| GSM2 | None | 70.8 | 0.498 | 1.75 | None | 27.5 | −57.4% | 416.5 | 38.1 |
| (Comp.) | | | | | | | | | |
| GSM3 | None | 70.8 | 0.498 | 1.25 | None | 25.3 | −90.1% | 452.0 | 34.0 |
| (Comp.) | | | | | | | | | |
| GSM4 | None | 70.8 | 0.498 | 1.00 | None | 24.3 | −95.9% | 476.3 | 31.4 |
| (Comp.) | | | | | | | | | |
| GSM8 | 112 | 69.5 | 0.489 | 1.75 | None | 26.7 | −4.5% | 685.1 | 37.0 |
| GSM9 | 112 | 69.5 | 0.489 | 1.25 | None | 25.5 | −3.1% | 897.0 | 33.2 |
| GSM10 | 112 | 69.5 | 0.489 | 1.00 | None | 25.3 | −4.5% | 1174.3 | 32.9 |
| GSM11 | 112 | 69.5 | 0.489 | 0.75 | None | 22.7 | −4.5% | 1645.0 | 30.8 |
| GSM12 | 112 | 69.5 | 0.489 | 0.50 | None | 21.9 | −3.5% | 1704.8 | 30.0 |
| GSM13 | 112 | 69.5 | 0.489 | 0.35 | None | 20.1 | −6.6% | 2104.4 | 27.1 |
| GSM17 | 112 | 68.8 | 0.482 | 1.75 | None | 26.9 | +5.3% | 652.2 | 34.6 |

Note:
Comp. means Comparative

In Table 7, the DL EO content and the DL thioether content were calculated from the concentrations and the identity of the used components in the applied DL compositions, excluding any inert solvent(s).

From the results Table 7 it can be seen that the GSMs according to the present invention have good CO₂/N₂ selectivity of at least 15 and good H₂S/CH₄ selectivity of at least 18 and good H₂S permeance of at least 400 GPU and good ageing stability, wherein the CO₂/N₂ selectivity does not decrease by more than 15% relative to a not aged sample.

Table 7 also shows that GSMs falling outside of the present claims (Comparative GSMs) perform less well. For example:
GSM30 has a DL EO content outside of the present claims and suffers from poor H₂S permeance (Q_{H2S}) and poor H₂S/CH₄ selectivity (α_{CH2S/CH4}).
GSM39 and GSM40 have DL thicknesses outside of the present claims and suffer from poor CO₂/N₂ selectivity (α_{CO2/N2}).
GSM32, GSM47 and GSM48 have a GL thickness outside of the present claims and suffers from poor H₂S permeance (Q_{H2S}).
GSM49 and GSM50 have a DL thickness outside of the present claims and suffers from poor H₂S permeance (Q_{H2S}).
GSM2, GSM3 and GSM4 have no gutter layer and suffer from poor ageing stability.
GSM46 does not comprise any thioether groups and suffers from poor H₂S/CH₄ selectivity (α_{H2S/CH4}).

In Table 7, when a GSM did not meet one of the requirements to be considered acceptable, then additional testing was often skipped and N/A (denoting ‘Not Available’) is mentioned for the skipped test. For example GSM36 had a CO₂/N₂ selectivity of only 7.1 and therefore further testing of this GSM was not performed.

1-9. (canceled)

10. A gas separation membrane comprising:
(i) a porous substrate;
(ii) a gutter layer comprising a cross-linked polysiloxane polymer;
(iii) a discriminating layer comprising at least 60 w/w % of ethylene oxide (EO) groups and at least 0.15 mmol/g of thioether groups; and
(iv) optionally a protective layer comprising a cross-linked polysiloxane polymer;
wherein:
(a) the gutter layer has an average thickness of less than 2.5 μm; and
(b) the discriminating layer has an average thickness of greater than 0.2 μm and less than 5 μm;
(c) the gas membrane has a H₂S permeance >400 GPU.

11. The gas separation membrane according to claim 10 wherein the discriminating layer has an average thickness between 0.3 μm and 3 μm.

12. The gas separation membrane according to claim 10 wherein said discriminating layer comprising thioether groups between 0.15 and 0.60 mmol/g.

13. The gas separation membrane according to claim 10 wherein the thioether groups are of the formula —CH₂—S—CH₂—.

14. The gas separation membrane according to claim 10 wherein the porous substrate comprises polyacrylonitrile, polysulphone, polyvinylidenefluoride, polyether ether ketone or polytetrafluoroethylene.

15. A process for preparing a gas separation membrane having a H₂S permeance >400 GPU comprising the steps of:
(i) forming a gutter layer of average thickness of less than 2.5 μm on a porous substrate;
(ii) forming on the gutter layer a discriminating layer comprising at least 60 w/w % of EO groups and at least 0.15 mmol/g of thioether groups, and having an average thickness greater than 0.2 μm and less than 5; and
(iii) optionally forming on the discriminating layer a protective layer comprising a cross-linked polysiloxane polymer.

16. A gas separation module comprising a gas separation membrane according to claim 10.

17. The gas separation module according to claim 16 wherein the gas separation membrane is in the form of a flat sheet, a spiral-wound sheet or a hollow-fibre.
